(19) United States
(12) Patent Application Publication
(10) Pub. No.: US 2009/0157615 A1
(43) Pub. Date: Jun. 18, 2009

(54) SYNCHING ONLINE ADDRESS BOOK SOURCES FOR A VEHICLE USER

(75) Inventors: Steven J. Ross, Livonia, MI (US); Steven C. Tengler, Grosse Point Park, MI (US); Richard A. Johnson, Rochester Hills, MI (US)

Correspondence Address: Julia Church Dierker;Dierker & Associates, P.C., 3331 W. Big Beaver Road, Suite 109, Troy, MI, 48084-2813, US

(73) Assignee: GENERAL MOTORS CORPORATION, DETROIT, MI (US)

(21) Appl. No.: 11/959,140

(22) Filed: Dec. 18, 2007

(51) Int. Cl. G06F 7/06; G01C 21/00; G06F 15/16

(52) U.S. Cl. 707/3; 701/200; 709/217; 707/E17.014

(57) ABSTRACT

A method for synching online address book sources for a vehicle user is disclosed. The method includes receiving, at a server, at least two different user selected destination entries from at least two different destination entry systems in selective communication with the server, and consolidating the destination entries received from the Internet-enabled programs into a personalized online and vehicle accessible address book.

### TECHNICAL FIELD

The present disclosure relates generally to methods and systems for synching online address book sources for a vehicle user.

### BACKGROUND

Numerous online websites enable users to enter a potential destination and receive maps of the destination area, directions to the destination, or the like. Some programs also enable the user to send the destination to another entity that is capable of generating turn-by-turn directions or downloading the destination to a navigation system embedded within a particular vehicle.

### SUMMARY

Method(s) and system(s) for synching online address book sources for a vehicle user are disclosed. An example of the method includes receiving, at a server, at least two different user selected destination entries from at least two different destination entry systems in selective communication with the server, and consolidating the destination entries received from the destination entry systems into a personalized online and vehicle accessible address book.

### BRIEF DESCRIPTION OF THE DRAWINGS

Features and advantages of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic diagram depicting an example of a system for synching online address book sources for a vehicle user; and

FIG. 2 is a schematic diagram depicting examples of information flow in a method for synching online address book sources for a vehicle user.

### DETAILED DESCRIPTION

Example(s) of the system and method disclosed herein provide a vehicle user with a personalized online and vehicle accessible address book consolidating destination entries from multiple Internet-enabled programs. The user may also upload destination entries to the personalized online and vehicle accessible address book from other email address book(s), electronic device address book(s), or the like, or combinations thereof. The system and methods disclosed herein advantageously enable a vehicle user to maintain a single consolidated address book without having to manually consolidate the entries.

It is to be understood that, as used herein, the term “user” includes vehicle owners, operators, and/or passengers. It is to be further understood that the term “user” may be used interchangeably with subscriber/service subscriber.

The terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in communication with the other component (notwithstanding the presence of one or more additional components therebetween). Additionally, two components may be permanently, semi-permanently, or releasably engaged with and/or connected to one another.

It is to be further understood that “communication” is to be construed to include all forms of communication, including direct and indirect communication. Indirect communication may include communication between two components with additional component(s) located therebetween.

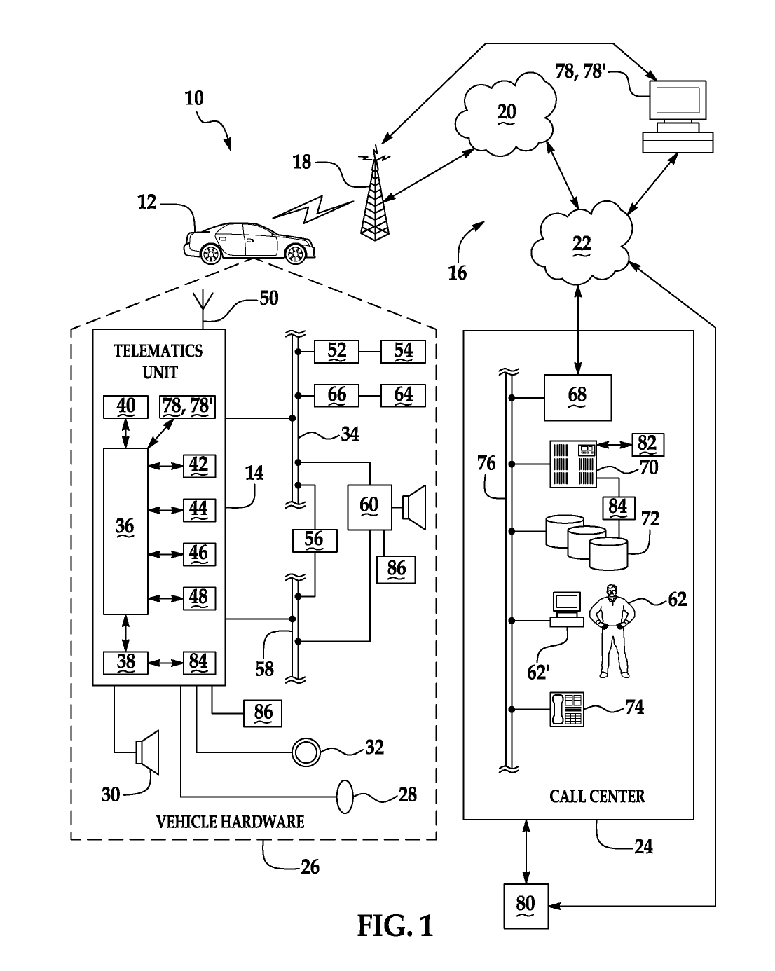

Referring now to FIG. 1, the system 10 includes a vehicle 12, a telematics unit 14, a wireless carrier/communication system 16 (including, but not limited to, one or more cell towers 18, one or more base stations and/or mobile switching centers (MSCs) 20, one or more land networks 22, one or more service providers (not shown)), and one or more call centers 24. In an example, the wireless carrier/communication system 16 is a two-way radio frequency communication system.

The system 10 also includes two or more different destination entry systems 78, 78′ that are in selective communication with the server 70 (and associated software 82) of the call center 24 (e.g., via wireless carrier/communication system 16 or some other suitable communication system). In one example, the destination entry systems 78, 78′ are supported and hosted by one or more servers (not shown) that are capable of communicating with both the vehicle 12 and the call center 24. In another example, the destination entry systems 78, 78′ host server(s) may send information to and receive information from the call center 24, and the call center 24 may then communicate with vehicle 12. In still other examples, the destination entry systems 78, 78′ are in-vehicle navigation systems and telematics units 14 of one or more vehicles 12.

Furthermore, the system 10 may include an additional address book 80. The data (e.g., destination entries, vehicle personal calling number(s), URLs, emergency contact information, etc.) contained in the additional address book 80 is capable of being retrieved by the server 70, and uploaded into a user's personalized online and vehicle accessible address book 84 (described further hereinbelow). As such, the server 70 is in selective communication with the entity hosting and/or supporting the additional address book 80. The address book 80 may be, for example, a user's online address book, a user's email address book or a user's electronic device address book.

The overall architecture, setup and operation, as well as many of the individual components of the system 10 shown in FIG. 1 are generally known in the art. Thus, the following paragraphs provide a brief overview of one example of such a system 10. It is to be understood, however, that additional components and/or other systems not shown here could employ the method(s) disclosed herein.

Vehicle 12 is a mobile vehicle such as a motorcycle, car, truck, recreational vehicle (RV), boat, plane, etc., and is equipped with suitable hardware and software that enables it to communicate (e.g., transmit and/or receive voice and data communications) over the wireless carrier/communication system 16. It is to be understood that the vehicle 12 may also include additional components suitable for use in the telematics unit 14.

Some of the vehicle hardware 26 is shown generally in FIG. 1, including the telematics unit 14 and other components that are operatively connected to the telematics unit 14. Examples of such other hardware 26 components include a microphone 28, a speaker 30 and buttons, knobs, switches, keyboards, and/or controls 32. Generally, these hardware 26 components enable a user to communicate with the telematics unit 14 and any other system 10 components in communication with the telematics unit 14.

Operatively coupled to the telematics unit 14 is a network connection or vehicle bus 34. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few. The vehicle bus 34 enables the vehicle 12 to send and receive signals from the telematics unit 14 to various units of equipment and systems both outside the vehicle 12 and within the vehicle 12 to perform various functions, such as unlocking a door, executing personal comfort settings, and/or the like.

The telematics unit 14 is an onboard device that provides a variety of services, both individually and through its communication with the call center 24. The telematics unit 14 generally includes an electronic processing device 36 operatively coupled to one or more types of electronic memory 38, a cellular chipset/component 40, a wireless modem 42, a navigation unit containing a location detection (e.g., global positioning system (GPS)) chipset/component 44, a real-time clock (RTC) 46, a short-range wireless communication network 48 (e.g., a Bluetooth® unit), and/or a dual antenna 50. In one example, the wireless modem 42 includes a computer program and/or set of software routines executing within processing device 36.

It is to be understood that the telematics unit 14 may be implemented without one or more of the above listed components, such as, for example, the short-range wireless communication network 48. It is to be further understood that telematics unit 14 may also include additional components and functionality as desired for a particular end use.

The electronic processing device 36 may be a micro controller, a controller, a microprocessor, a host processor, and/or a vehicle communications processor. In another example, electronic processing device 36 may be an application specific integrated circuit (ASIC). Alternatively, electronic processing device 36 may be a processor working in conjunction with a central processing unit (CPU) performing the function of a general-purpose processor.

The location detection chipset/component 44 may include a Global Position System (GPS) receiver, a radio triangulation system, a dead reckoning position system, and/or combinations thereof. In particular, a GPS receiver provides accurate time and latitude and longitude coordinates of the vehicle 12 responsive to a GPS broadcast signal received from a GPS satellite constellation (not shown).

The cellular chipset/component 40 may be an analog, digital, dual-mode, dual-band, multi-mode and/or multi-band cellular phone.

Also associated with electronic processing device 36 is the previously mentioned real time clock (RTC) 46, which provides accurate date and time information to the telematics unit 14 hardware and software components that may require and/or request such date and time information. In an example, the RTC 46 may provide date and time information periodically, such as, for example, every ten milliseconds.

The telematics unit 14 provides numerous services, some of which may not be listed herein. Several examples of such services include, but are not limited to: turn-by-turn directions and other navigation-related services provided in conjunction with the GPS based chipset/component 44; airbag deployment notification and other emergency or roadside assistance-related services provided in connection with various crash and or collision sensor interface modules 52 and sensors 54 located throughout the vehicle 12; and infotainment-related services where music, Web pages, movies, television programs, videogames and/or other content is downloaded by an infotainment center 56 operatively connected to the telematics unit 14 via vehicle bus 34 and audio bus 58. In one non-limiting example, downloaded content is stored (e.g., in memory 38) for current or later playback.

Again, the above-listed services are by no means an exhaustive list of all the capabilities of telematics unit 14, but are simply an illustration of some of the services that the telematics unit 14 is capable of offering.

Vehicle communications preferably use radio transmissions to establish a voice channel with wireless carrier system 16 such that both voice and data transmissions may be sent and received over the voice channel. Vehicle communications are enabled via the cellular chipset/component 40 for voice communications and the wireless modem 42 for data transmission. In order to enable successful data transmission over the voice channel, wireless modem 42 applies some type of encoding or modulation to convert the digital data so that it can communicate through a vocoder or speech codec incorporated in the cellular chipset/component 40. It is to be understood that any suitable encoding or modulation technique that provides an acceptable data rate and bit error may be used with the examples disclosed herein. Generally, dual mode antenna 50 services the location detection chipset/component 44 and the cellular chipset/component 40.

Microphone 28 provides the user with a means for inputting verbal or other auditory commands, and can be equipped with an embedded voice processing unit utilizing human/machine interface (HMI) technology known in the art. Conversely, speaker 30 provides verbal output to the vehicle occupants and can be either a stand-alone speaker specifically dedicated for use with the telematics unit 14 or can be part of a vehicle audio component 60. In either event and as previously mentioned, microphone 28 and speaker 30 enable vehicle hardware 26 and call center 24 to communicate with the occupants through audible speech. The vehicle hardware 26 also includes one or more buttons, knobs, switches, keyboards, and/or controls 32 for enabling a vehicle occupant to activate or engage one or more of the vehicle hardware components. In one example, one of the buttons 32 may be an electronic pushbutton used to initiate voice communication with the call center 24 (whether it be a live advisor 62 or an automated call response system 62′). In another example, one of the buttons 32 may be used to initiate emergency services.

The audio component 60 is operatively connected to the vehicle bus 34 and the audio bus 58. The audio component 60 receives analog information, rendering it as sound, via the audio bus 58. Digital information is received via the vehicle bus 34. The audio component 60 provides AM and FM radio, satellite radio, CD, DVD, multimedia and other like functionality independent of the infotainment center 56. Audio component 60 may contain a speaker system, or may utilize speaker 30 via arbitration on vehicle bus 34 and/or audio bus 58. The audio component 60 may also include software for receiving alerts from other vehicles 12 using the method(s) disclosed herein.

The vehicle crash and/or collision detection sensor interface 52 is/are operatively connected to the vehicle bus 34. The crash sensors 54 provide information to the telematics unit 14 via the crash and/or collision detection sensor interface 52 regarding the severity of a vehicle collision, such as the angle of impact and the amount of force sustained.

Other vehicle sensors 64, connected to various sensor interface modules 66 are operatively connected to the vehicle bus 34. Example vehicle sensors 64 include, but are not limited to, gyroscopes, accelerometers, magnetometers, emission detection and/or control sensors, and/or the like. Non-limiting example sensor interface modules 66 include powertrain control, climate control, body control, and/or the like.

In a non-limiting example, the vehicle hardware 26 includes a display 86, which may be operatively connected to the telematics unit 14 directly, or may be part of the audio component 60. Non-limiting examples of the display 86 include a VFD (Vacuum Fluorescent Display), an LED (Light Emitting Diode) display, a driver information center display, a radio display, an arbitrary text device, a heads-up display (HUD), an LCD (Liquid Crystal Diode) display, and/or the like.

Wireless carrier/communication system 16 may be a cellular telephone system or any other suitable wireless system that transmits signals between the vehicle hardware 26 and land network 22, and between the destination entry systems 78, 78′ and the land network 22. According to an example, wireless carrier/communication system 16 includes one or more cell towers 18, base stations and/or mobile switching centers (MSCs) 20, as well as any other networking components required to connect the wireless system 16 with land network 22. It is to be understood that various cell tower/base station/MSC arrangements are possible and could be used with wireless system 16. For example, a base station 20 and a cell tower 18 may be co-located at the same site or they could be remotely located, and a single base station 20 may be coupled to various cell towers 18 or various base stations 20 could be coupled with a single MSC 20. A speech codec or vocoder may also be incorporated in one or more of the base stations 20, but depending on the particular architecture of the wireless network 16, it could be incorporated within a Mobile Switching Center 20 or some other network components as well.

Land network 22 may be a conventional land-based telecommunications network that is connected to one or more landline telephones and connects wireless carrier/communication network 16 and destination entry systems 78, 78′ to call center 24. For example, land network 22 may include a public switched telephone network (PSTN) and/or an Internet protocol (IP) network. It is to be understood that one or more segments of the land network 22 may be implemented in the form of a standard wired network, a fiber of other optical network, a cable network, other wireless networks such as wireless local networks (WLANs) or networks providing broadband wireless access (BWA), or any combination thereof.

Call center 24 is designed to provide the vehicle hardware 26 with a number of different system back-end functions and, according to the example shown here, generally includes one or more switches 68, servers 70 and software 82 associated therewith, databases 72, live and/or automated advisors 62, 62′, as well as a variety of other telecommunication and computer equipment 74 that is known to those skilled in the art. These various call center components are coupled to one another via a network connection or bus 76, such as the one (vehicle bus 34) previously described in connection with the vehicle hardware 26.

As shown, the server 70 may be associated with software 82, which supports an online destination entry program that is accessible to subscribers via the Internet. As described further hereinbelow, the server 70 and software 82 work together to create, for a user, the personalized online and vehicle accessible address book 84.

In other instances, the subscriber may access one or more independent (i.e., not associated with the server 70 and/or software 82) destination entry systems 78, 78′ (e.g., third party geographic information service (GIS)/routing service provider, such as MapQuest®) directly via the Internet. The third party server sends the destination information to the call center 24. The call center 24 network then allows the GIS/routing service provider to access the personalized online and vehicle accessible address book 84 (i.e., to upload information thereto) or allows the call center 24 to access an address book associated with the destination entry systems 78, 78′ (i.e., to upload information therefrom).

In still other instances, the subscriber may access the destination entry system 78, 78′ via in-vehicle destination means (e.g., provided by an autonomous navigation system integral in the telematics unit 14), or via some other non-Internet enabled destination entry system. A non-limiting example of such a non-Internet enabled destination entry system is a call center advisor 62, 62′ providing destination entry assistance.

The live advisor 62 may be physically present at the call center 24 or may be located remote from the call center 24 while communicating therethrough.

Switch 68, which may be a private branch exchange (PBX) switch, routes incoming signals so that voice transmissions are usually sent to either the live advisor 62 or an automated response system 62′, and data transmissions are passed on to a modem (not shown) or other piece of equipment for demodulation and further signal processing. The modem preferably includes an encoder, as previously explained, and can be connected to various devices such as the server 70 and database 72. For example, database 72 may be designed to store subscriber personalized online and vehicle accessible address books 84, subscriber profile records, subscriber behavioral patterns, or any other pertinent subscriber information. Although the illustrated example has been described as it would be used in conjunction with a manned call center 24, it is to be appreciated that the call center 24 may be any central or remote facility, manned or unmanned, mobile or fixed, to or from which it is desirable to exchange voice and data communications.

It is to be understood that, although a service provider (not shown) may be located at the call center 24, the call center 24 is a separate and distinct entity from the service provider. In an example, the service provider is located remote from the call center 24. A service provider provides the user with telephone and/or Internet services. In an example, the service provider is a wireless carrier (such as, for example, Verizon Wireless®, AT&T®, Sprint®, etc.). It is to be understood that the service provider may interact with the call center 24 to provide service(s) to the user.

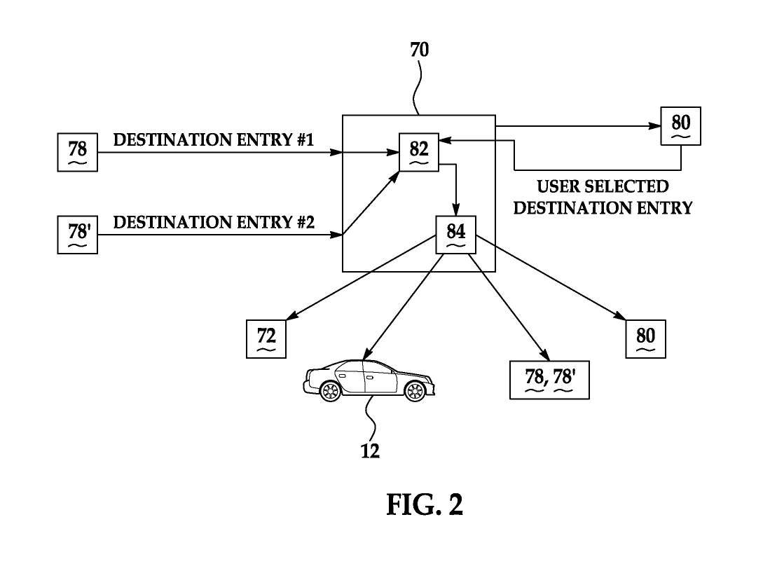

Referring now to FIG. 2, examples of information flow in various aspects of the method are depicted. Generally, the method includes receiving, at the server 70 (of the call center 24), at least two different user selected destination entries (e.g., #1 and #2 shown in FIG. 2) from at least two different destination entry systems 78, 78′.

When one or more of the destination entry systems 78, 78′ are Internet-enabled programs, the user accesses such system 78, 78′ via a computer or other electronic device (e.g., desktop, notebook, mobile phone, or personal digital assistant) configured to access the Internet. In an example, the computer or other electronic device includes, or is in communication with, an input device (e.g., a keyboard and/or mouse) and a display (e.g., a monitor and/or one or more speakers). It is to be understood that the communication between the computer or other electronic device and the server hosting the destination entry systems 78, 78′ may be wired and/or wireless.

The computer or other electronic device is generally at a location that is remote from the vehicle 12. However, it is to be understood that the computer or other electronic device may be a portable device that is used in the vehicle 12. The user accesses a personalized account at the respective destination entry systems 78, 78′ by inputting user-specific information. The user specific information may include, for example, the user's name, a password, an account number, and/or any other identifying information. It is to be understood that the personalized account information may be stored and/or accessed by the server (not shown) hosting the respective destination entry system 78, 78′ (e.g., an Internet-enabled program).

Internet-enabled destination entry systems 78, 78′ may be those that enable a user to input destination entries or locations to obtain maps, directions, postal information, or the like. Non-limiting examples of such destination entry systems 78, 78′ include map/direction generating websites, postal service websites, search engine websites, or the like. Other destination entry systems 78, 78′ that are Internet-enabled include programs and devices that have Internet connectivity, such as Microsoft® Outlook running on a personal computer, a phone/address list application running on an Internet-enabled personal digital assistant (PDA), an application running on a telematics unit 14, or the like. In some instances, the destination entry systems 78, 78′ give the user the option to store such destination entries for later use (e.g., in an online address book).

Once the user is granted access to his/her Internet-enabled program account, the destination entry systems 78, 78′ prompts the user to input or select a destination entry. Inputting the destination entry involves the user inputting an address, a partial address (e.g., city, zipcode, etc.), a place name (e.g., points of interest), an intersection, or combinations thereof. Selecting a destination entry involves the user selecting, from a previously generated list, a particular destination. Other information (in addition to the destination entry) that may be input or selected includes vehicle personal calling numbers, URLs, emergency contact information, and/or the like, and/or combinations thereof. It is to be understood that such information may also be included in the address book 84.

Generally, the server(s) hosting the respective Internet-enabled destination entry system 78, 78′ partners with the server 70 located at the call center 24. As such, the destination entry system 78, 78′ offers to the user the option of linking his/her Internet-enabled program account with his/her subscriber account (i.e., vehicle telematics service account) maintained via the server 70 and call center 24. If the user chooses to link the accounts, the destination entry system 78, 78′ contacts the server 70 to set up such a link. Thereafter, upon recognizing that the user has accessed his/her Internet-enabled program account, the server(s) supporting the destination entry systems 78, 78′ is able to recognize the link with the user's subscriber account and to transmit any user input or selected destination entries to the server 70 (supporting the subscriber account).

It is to be understood that in some instances communication between the respective destination entry systems 78, 78′ and the server 70 is accomplished via the wireless carrier/communication system 16.

Once the user has entered/selected the destination entry via the destination entry systems 78, 78′, he/she may save such information in his/her account and may transmit such information to the server 70. In one example, the saved destination entries is/are stored at a location remote from the computer or other electronic device being used to access the destination entry systems 78, 78′. As such, the entries may be accessible to a user from any device capable of accessing the destination entry systems 78, 78′. In another example, the entries are stored locally at the device where they were previously created. In such an example, an abbreviated list may be accessible at any single device, the abbreviated list including those entries that were input or selected at that particular device.

The storage of the entries in the user's Internet-enabled program account enables him/her to retrieve the information at a later date for updating, changing or deleting such information. It is to be understood that if/when a user selects, inputs or updates information locally at his/her Internet-enabled program account, the Internet-enabled destination entry system 78, 78′ transmits such information to the server 70 (previously linked to the Internet-enabled program account).

In some instances, the destination entry system 78, 78′ is the in-vehicle navigation system. Entries in such a system may be input by the user, downloaded by the call center 24, and/or transmitted from an Internet-enabled destination entry system 78, 78′. It is to be understood that destination entries may be saved after a user requests navigation instructions to such destination entries.

The server 70 (e.g., in response to a request from the user or upon its own initiative) may contact the navigation system (e.g., the navigation unit containing the location detection chipset/component 44) that is integral with the telematics unit 14 of the user's vehicle 12. Non-limiting examples of such navigation systems include a vehicle autonomous navigation and/or a turn by turn navigation system. The server 70 uploads one or more destination entries that is/are stored in the navigation system. Once the entries are uploaded, they are used to generate the personalized online and vehicle accessible address book 84 (e.g., if the user does not have one associated with his/her account) or are consolidated with the contents of the user's existing personalized online and vehicle accessible address book 84.

Generally, the telematics unit 14 contacted is one that is associated with a vehicle 12 of the user (i.e., the user associated with the particular address book 84). In some instances, however, the telematics unit 14 contacted may be located in a vehicle 12 that is not the users. In these instances, the vehicle 12 owner may be contacted to give permission to upload destination entries from his/her navigation system.

When destination entries are uploaded from the desirable telematics unit 14, such destination entries may then be downloaded to other vehicles 12 that are associated with the user's personal profile or account.

It is to be understood that different destination entries from different destination entry systems 78, 78′ may be received by the server 70 simultaneously or at different times.

Once at least one entry is received by the server 70, the server 70 and software 82 generate the personalized online and vehicle accessible address book 84 for the particular user. When two or more entries are subsequently received, the additional entries are consolidated into the address book 84. In addition to destination entries, the address book 84 may also include entries related to vehicle personal calling numbers, URLs, emergency contact information, and/or the like, and/or combinations thereof.

It is to be understood that since the user's Internet-enabled program accounts have been linked to his/her subscriber account, the server 70 is able to recognize which user the received entries belong to. As such, the receipt of a single entry for a particular user acts as a trigger for the initial generation of the personalized online and vehicle accessible address book 84.

Once the address book 84 is generated, it may be stored via the server 70 and may be accessible to the user online via an Internet-enabled program supported by the server 70 (e.g., an online destination entry program). The address book 84 may also be downloaded to the database 72 located at the call center 24, to the telematics unit 14 located in the vehicle 12, to the various destination entry systems 78, 78′, and/or to another address book 80 (as shown in FIG. 2). As such, the online and vehicle accessible address book 84 may be accessed via the call center service advisors 62, 62′, the telematics unit buttons, knobs, switches, keyboards, and/or controls 32, the Internet, or an electronic device containing the address book 84. In an example in which the address book 84 is stored in the telematics unit memory 38, the user may request that the address book 84 be displayed via in-vehicle display 86.

The entries may be consolidated and prioritized in any suitable manner. The user may define categories (e.g., favorite restaurants, favorite points of interest, etc.) for prioritization. The address book 84 may also be prioritized according to particular points of interest, alphabetically, geographically, or the like within the address book 84. It is to be understood that the address book 84 may also be cross-referenced with a user's calendar, such that the order of the entries appears in the order of a particular day's appointments.

The software 82 and server 70 are configured to determine whether the two or more received entries correspond to the same destination location. If the two entries are determined to correspond to the same location, the software 82 and server 70 evaluate the geo-coded information (e.g., full address, partial address, place name, etc.) for each entry. Generally, the software 82 and server 70 select the entry having more inclusive geo-coded information. It is to be understood, however, that if the geo-coded information for the first entry is more inclusive, but the geo-coded information for the second entry includes information that is not included in the first entry, the software 82 and server 70 may create an address book 84 entry for the first entry and include the additional information from the second entry.

The software 82 and server 70 are also configured to receive additional destination entries whenever the user accesses and inputs/selects a destination entry via a destination entry system 78, 78′ linked to the server 70. Upon receiving an additional entry, the software 82 and server 70 determine whether the additional entry should be incorporated into the personalized online and vehicle accessible address book 84. If no such destination entry exists in the address book 84, an entry for this destination location is created and stored. If however, the newly received destination entry corresponds to an existing destination entry in the address book 84, the software 82 and server 70 will compare the received entry with the existing entry to determine which entry has more inclusive geo-coded information. In one example, if the newly received entry contains no additional geo-coded information, the newly received entry is deleted and the existing destination entry is maintained. In another example, if the newly received entry contains more inclusive geo-coded information, the newly received entry will replace (i.e., be saved over) the previously existing entry. In still another example, if the newly received entry includes additional but different information from the existing entry, the software 82 and server 70 may update the existing entry with the additional different information and then delete the newly received entry.

It is to be understood that when the server 70 updates the entries in the online address book 84, the updated version may be sent to the database 72, destination entry system(s) 78, 78′, the other address book 80, and/or telematics unit 14 for storage therein.

In an example, the server 70 may contact the user and inquire as to whether he/she would like to upload (to the address book 84) one or more destination entries from another address book 80. As previously described, this address book 80 may be an online address book (e.g., an email address book) of the user or an address book associated with an electronic device (e.g., a cellular phone, a personal digital assistant, a computer, etc.).

In some instances, the server 70 may recognize that the user has the other online address book 80 prior to contacting the user. As one example, if the server 70 receives numerous destination entries from a specific destination entry system 78, 78′, the server 70 may conclude that the user likely maintains an account and an address book 80 with that destination entry system 78, 78′. As another example, the server 70 may monitor other destination entry systems 78, 78′ for user activity. In an example where the destination entry system 78, 78′ is an Internet-enabled program, user account verification (e.g., login and password) at one of the Internet-enabled destination entry systems 78, 78′ may be a trigger for the server 70 to recognize the possibility that the user maintains an account and an address book 80 with that Internet-enabled destination entry system 78, 78′. This may be accomplished by the user clicking a hyperlink at the destination entry system 78, 78′ which enables the server 70 to check for the existence of an address book 80. In response, the server 70 may contact the user inquiring as to whether he/she actually maintains such an address book 80, and if so, whether he/she wishes to upload the entire other address book 80 to the online and vehicle accessible address book 84.

If the user wishes to upload one or more additional destination entries, the user informs the server 70 of his/her selection(s). The server 70 and user may be in communication via email, audio messaging, text messaging, or combinations thereof.

Upon receiving the user's selection(s) (which may include one, multiple or the entire address book 80 contents), the server 70 then accesses the online address book or the electronic device address book and uploads the user selected destination entries to the address book 84. It is to be understood that the uploaded entries are then consolidated and prioritized (e.g., via user-specified categories, points of interest, alphabetically, geographically, or the like) within the address book 84. Generally, duplicate entries are ignored or updated with new information, and new entries are added to the address book 84. As previously described, the consolidated address book 84 may be downloaded to and saved in the vehicle 12, an electronic device, the destination entry system 78, 78′, the server 70 and/or the database 72 of the call center 24.

In this example, the server 70 may also inquire as to which destination entry system 78, 78′ the user prefers to interact with. If the user selects a destination entry system 78, 78′ other than the one supported by the server 70, the server 70 may download the consolidated address book 84 to the destination entry system 78, 78′ of the user's choice. This way, the user may interact with a preferred destination entry system 78, 78′.

As a non-limiting example of using the address book 84, the user may request that the call center service advisor 62, 62′ or an on-board navigation device generate directions/navigation instructions to one of the destination entries stored in the address book 84 and selected by the user. In response, the call center service advisor 62, 62′ or an on-board navigation device retrieves the destination entry from the address book 84, generates the requested directions/navigation instructions, and transmits the directions/navigation instructions to the user (e.g., via the audio component 60 and/or display 86).

As another non-limiting example of using the address book 84, the user may access the address book 84 online, select one of the destination entries from the address book 84, and request that the destination information be downloaded to the vehicle 12 upon the next ignition cycle to provide directions/navigation instructions from the then-current vehicle position to the selected destination entry.

In still another non-limiting example of using the address book 84, in response to a request for navigation instructions to one of the address book 84 destination entries, the telematics unit 14 retrieves a previously stored set of directions to that particular destination entry. Prior to being able to retrieve stored navigation instructions, the telematics unit 14 will have had to generate such instructions and store such instructions therein (e.g., in memory 38). Generally, the generation and storage occurs in response to an initial request from the user.

Once the telematics unit 14 initially generates and stores the navigation instructions, when the user selects a destination entry from the address book 84 and sends it to the telematics unit 14, the telematics unit 14 may simply retrieve (and transmit to the user) the previously stored navigation instructions to that particular location.

In the example methods and systems disclosed herein, the server 70 may be configured to query one or more destination entry systems 78, 78′ to retrieve a particular user's destination entries stored in an account associated with the one or more destination entry systems 78, 78′. Generally, the server 70 performs this service after the user has created and made accessible to the server 70 a list of destination entry systems 78, 78′ with which the user maintains an account. In addition to the name or web address of the destination entry system 78, 78′, the list also includes verification passwords and/or user log in identifiers or aliases associated with such accounts. Generally, the user gives the server 70 permission to access the user accounts on the list. As such, the server 70 can access numerous user accounts and consolidate (into the address book 84) address book entries stored within these accounts without the user's active involvement.

The system and method disclosed herein enable the consolidation of a user's online and in-vehicle destination entries (entered and stored in multiple destination entry systems 78, 78′) into a single online and vehicle accessible address book 84. As described herein, this may advantageously be accomplished without the user having to do the consolidating.

While several examples have been described in detail, it will be apparent to those skilled in the art that the disclosed examples may be modified. Therefore, the foregoing description is to be considered exemplary rather than limiting.

1. A method for synching online address book sources for a vehicle user, the method comprising:
receiving, at a server, at least two different user selected destination entries from at least two different destination entry systems in selective communication with the server; and
consolidating the destination entries received from the destination entry systems into a personalized online and vehicle accessible address book.

2. The method as defined in claim 1 wherein at least one of the at least two different destination entry systems is an Internet-enabled program, and wherein the method further comprises:
inputting a destination entry at the Internet-enabled program;
inputting account verification information at the Internet-enabled program; and
transmitting the destination entry from the Internet-enabled program to the server.

3. The method as defined in claim 1, further comprising:
contacting a user; and
inquiring whether the user wants to upload one or more destination entries from an email address book or an electronic device address book to the personalized online and vehicle accessible address book.

4. The method as defined in claim 3 wherein if the user wants to upload the one or more destination entries, the method further comprises inquiring as to which destination entry system the user prefers to interact with.

5. The method as defined in claim 3 wherein if the user wants to upload the one or more destination entries, the method further comprises:
receiving a user selected destination entry; and
incorporating the user selected destination entry into the personalized online and vehicle accessible address book.

6. The method as defined in claim 5 wherein the user selected destination entry is received in a form selected from an email, an audio message, a textual message, or combinations thereof.

7. The method as defined in claim 1, further comprising:
determining whether two or more of the received user selected destination entries correspond to a same location;
evaluating the two or more received user selected destination entries for geo-coded information; and
selecting, for the personalized online and vehicle accessible address book, one of the two or more received user selected destination entries including more inclusive geo-coded information.

8. The method as defined in claim 1, further comprising:
receiving, at the server, an additional user selected destination entry; and
determining whether to incorporate the additional user selected destination entry into the personalized online and vehicle accessible address book.

9. The method as defined in claim 8, further comprising:
determining that the additional user selected destination entry corresponds to an existing user selected destination entry in the personalized online and vehicle accessible address book;
determining which of the existing user selected destination entry and the additional user selected destination entry has more inclusive geo-coded information; and
if the additional user selected destination entry has more inclusive geo-coded information, replacing the existing user selected destination entry with the additional user selected destination entry.

10. The method as defined in claim 8, further comprising:
determining that additional user selected destination entry corresponds to an existing user selected destination entry in the personalized online and vehicle accessible address book;
determining which of the existing user selected destination entry and the additional user selected destination entry has more inclusive geo-coded information; and
if the existing user selected destination entry has more inclusive geo-coded information, maintaining the existing user selected destination entry in the personalized online and vehicle accessible address book.

11. The method as defined in claim 1, further comprising:
querying a destination entry system having an other online address book associated with a user for at least one additional user selected destination entry; and
uploading the at least one additional user selected destination entry to the personalized online and vehicle accessible address book.

12. The method as defined in claim 1, further comprising:
recognizing that a user of the personalized online and vehicle accessible address book has at least one other online address book;
contacting the user; and
inquiring whether the user wants to synchronize the at least one other online address book with the personalized online and vehicle accessible address book.

13. The method as defined in claim 12 wherein if the user wants to synchronize the address books, the method further comprises:
querying a destination entry system associated with the at least one other online address book for then-current contents of the at least one other online address book; and
consolidating the then-current contents of the at least one other online address book with contents of the personalized online and vehicle accessible address book.

14. The method as defined in claim 13, further comprising providing the consolidated personalized online and vehicle accessible address book to at least one of a vehicle associated therewith, a predetermined electronic device, or a predetermined destination entry system.

15. The method as defined in claim 1, further comprising:
receiving a request for navigation instructions to a user selected destination entry stored in the personalized online and vehicle accessible address book; and
transmitting the navigation instructions to a vehicle of a user associated with the personalized online and vehicle accessible address book.

16. The method as defined in claim 15 wherein prior to transmitting the navigation instructions, the method further comprises retrieving the navigation instructions from a telematics unit in the vehicle.

17. The method as defined in claim 1 wherein at least one of the at least two different destination entry systems is a navigation system integral to a telematics unit of a vehicle of a user associated with the personalized online and vehicle accessible address book.

18. The method as defined in claim 17, further comprising downloading the destination entry received from the navigation system to an other telematics unit of an other vehicle associated with the user.

19. A system for synching online address book sources for a vehicle user, the system comprising:
at least two different destination entry systems;
a server in selective communication with the at least two different destination entry systems and configured to receive at least two different user selected destination entries from the at least two different destination entry systems; and
means for consolidating the destination entries received from the destination entry systems into a personalized online and vehicle accessible address book.

20. The system as defined in claim 19, further comprising:
means for determining whether two or more of the received user selected destination entries correspond to a same location;
means for evaluating the two or more received user selected destination entries for geo-coded information; and
means for selecting, for the personalized online and vehicle accessible address book, one of the two or more received user selected destination entries including more inclusive geo-coded information.

21. The system as defined in claim 19 wherein the server is configured to receive additional user selected destination entries, and wherein the system further comprises:
means for determining that an additional user selected destination entry corresponds to an existing user selected destination entry in the personalized online and vehicle accessible address book;
means for determining which of the existing user selected destination entry and the additional user selected destination entry has more inclusive geo-coded information;
means for replacing the existing user selected destination entry with the additional user selected destination entry if the additional user selected destination entry has more inclusive geo-coded information; and
means for maintaining the existing user selected destination entry in the personalized online and vehicle accessible address book if the existing user selected destination entry has more inclusive geo-coded information.

22. The system as defined in claim 19, further comprising an in-vehicle telematics unit in operative communication with the server and configured to receive the personalized online and vehicle accessible address book from the server.

23. The system as defined in claim 19, further comprising:
means for receiving a request for navigation instructions to a user selected destination entry stored in the personalized online and vehicle accessible address book;
means for generating or retrieving the requested navigation instructions; and
means for transmitting the generated navigation instructions to a vehicle of a user associated with the personalized online and vehicle accessible address book.

24. The system as defined in claim 19, further comprising a call center at which the server is located.

25. A system for synching online address book sources for a vehicle user, the system comprising:
an Internet-enabled destination entry system;
an in-vehicle destination entry system;
a call center, including:
a server that is in selective communication with the Internet-enabled destination entry system and the in-vehicle destination entry system, and that is configured to selectively receive user selected destination entries from each of the Internet-enabled destination entry system and the in-vehicle destination entry system; and
an evaluation system for determining if two or more of the received user selected destination entries are the same, extracting geo-coded information from each of the received user selected destination entries if they are the same, and generating a single user selected destination entry that corresponds to the same received user selected destination entries and includes at least some of the extracted geo-coded information; and
a personalized online and vehicle accessible address book including multiple entries, at least one of which is the single user selected destination entry.

26. The system as defined in claim 25 wherein two or more of the received user selected destination entries are the same, and wherein the evaluation system is configured to select one of the two or more received user selected destination entries having more inclusive geo-coded information as an entry in the personalized online and vehicle accessible address book.
